(19) United States
(12) Patent Application Publication
(10) Pub. No.: US 2026/0313599 A1
(43) Pub. Date: Oct. 8, 2026

(54) TIME-OF-ARRIVAL DETERMINATION FOR WIRELESS DATA COMMUNICATION

(71) Applicant: Nordic Semiconductor ASA, Trondheim (NO)

(72) Inventors: Vu TRAN HUY, Farnham (GB); Robert JACKSON, Farnham (GB)

(73) Assignee: Nordic Semiconductor ASA, Trondheim (NO)

(21) Appl. No.: 19/629,929

(22) Filed: Mar. 26, 2026

(30) Foreign Application Priority Data
Apr. 3, 2025 (GB) 2505027.9

(51) Int. Cl. H04W 64/00; H04L 25/02

(52) U.S. Cl. CPC H04W 64/00; H04L 25/0248

(57) ABSTRACT

An electronic wireless communication device, comprises a receiver, arranged to receive a wireless data communication. The electronic wireless communication device is configured to carry out a time-of-arrival calculation to determine a time-of-arrival of the received wireless data communication. The calculation comprises generating, using at least signal eigenvectors derived from the received wireless data communication, at least one candidate time-of-arrival value for the received wireless data communication, generating, using at least noise eigenvectors derived from the received wireless data communication, a value of a likelihood measure for each of the generated candidate time-of-arrival values, and selecting a value of the candidate time-of-arrival values as the determined time-of-arrival for the received wireless data communication, based at least on the values of the likelihood measure.

### CROSS-REFERENCE TO RELATED APPLICATION

This application claims priority from United Kingdom Patent Application No. 2505027.9, filed Apr. 3, 2025, which application is incorporated herein by reference in its entirety.

### TECHNICAL FIELD

The present invention relates to an electronic wireless communication device, a wireless communication system and a method of carrying out a time-of-arrival calculation to determine a time-of-arrival of a received wireless data communication.

### BACKGROUND OF THE INVENTION

The present invention seeks to provide an improved method of determining a time-of-arrival of a received wireless data communication, and a device configured to carry out the method.

Location data of a user or device within a building has many possible uses and advantages. Typical applications may be situational adaptations which could be made in smart offices, factories, etc or use for navigation. For example, a voice command application could be provided which acts differently depending on the location at which a user is located (e.g. in a meeting room vs in an individual cubicle).

Localisation cannot be achieved indoors using GPS because the signal is attenuated to a high degree. Where signals are transmitted to or from a device within a building at a known speed (e.g. the speed of light, as for RF signals) it is theoretically possible to use the time of flight of those signals to derive the distance the signals have travelled and therefore the location of the one of the devices provided the location of the other device (or devices where more than two are communicating) are known. For example, the location of a number of reference devices (e.g. WiFi Access Points or APs) may be known.

Accurate measurement of the time of flight of a received wireless signal, sometimes referred to as Fine-Time-Measurement (FTM), therefore has enormous potential in many applications as it can be used to infer a device's location. Fine-Time-Measurement is a feature which has recently been introduced into WiFi standards to enable an AP to measure the distance between itself and a WiFi client device (e.g. a user's mobile telephone). The distance is indirectly estimated from the roundtrip time of RF waves traveling from a device to an AP and vice versa. Roundtrip time is derived from the time-of-departure and time-of-arrival of a predefined symbol or data. However, time-of-departure is trivial to determine since a device can straightforwardly obtain the timestamp at which it starts transmitting the symbol or data on its antenna. The accurate determination of roundtrip time therefore relies on accurately determining a time of arrival.

However, accurately determining the time of arrival (or timestamp at receipt) of a signal is not trivial for indoor signals. The signal can bounce off objects or be blocked, causing an offset in reception time, and thereby giving an inaccurate time of flight. Accurate FTM is particularly challenging for devices which have limited embedded resources primarily for two reasons-that low-power systems usually support limited WiFi bandwidth (e.g. 20 MHz), and that low-power systems usually do not have powerful CPUs to execute complicated algorithms.

### SUMMARY OF THE INVENTION

From a first aspect, the invention provides an electronic wireless communication device, comprising a receiver, arranged to receive a wireless data communication, the electronic wireless communication device configured to carry out a time-of-arrival calculation to determine a time-of-arrival of the received wireless data communication, the calculation comprising:
generating, using at least signal eigenvectors derived from the received wireless data communication, at least one candidate time-of-arrival value for the received wireless data communication;
generating, using at least noise eigenvectors derived from the received wireless data communication, a value of a likelihood measure for each of the generated candidate time-of-arrival values;
selecting a value of the candidate time-of-arrival values as the determined time-of-arrival for the received wireless data communication, based at least on the values of the likelihood measure.

The first aspect of the invention extends to a method of carrying out a time-of-arrival calculation to determine a time-of-arrival of a received wireless data communication, the method comprising:
generating, using at least signal eigenvectors derived from the received wireless data communication, at least one candidate time-of-arrival value for the received wireless data communication;
generating, using at least noise eigenvectors derived from the received wireless data communication, a value of a likelihood measure for each of the generated candidate time-of-arrival values;
selecting a value of the candidate time-of-arrival values as the determined time-of-arrival for the received wireless data communication, based at least on the values of the likelihood measure.

Thus the invention extends both to this method, and to a device configured to carry out this method.

Thus it will be seen that, in accordance with the invention, by generating a set of candidate time-of-arrival values (i.e. at least one, optionally a plurality), based at least on signal eigenvectors derived from the received data, and then determining values of a likelihood measure for each of these candidate values, using at least the noise eigenvectors, and selecting one as the determined arrival time based at least one the likelihood measure values, a method is provided for determining time of arrival of a received data signal (i.e. a method of fine-time measurement) which is both highly accurate, and which also requires relatively little computation. Generating a list of particular candidates, for which to calculate the value of the likelihood measure, reduces how many values the likelihood measure must be calculated for, compared to known methods which may calculate effectively a spectrum for the likelihood measure values and search for peaks in this spectrum. It therefore reduces the computational requirements compared to these methods. Using the likelihood measure to select the time-of-arrival from the candidates helps to take into account the likelihood of each candidate in fact being correct, and thereby improves the accuracy of the method, e.g. by helping to prevent a false candidate time-of-arrival value from being selected. Using both the signal and noise eigenvectors has thus been appreciated as providing an advantageous method which achieves high accuracy with relatively low computational costs.

The calculation (and the method) may be super-resolution, meaning that they achieve a higher resolution than the original received signals (i.e. wireless data communication).

A wireless data communication is received. It will be understood that this wireless data communication (i.e. received wireless signal) refers to all of the data which is received (e.g. at an antenna), in relation to a particular communication (e.g. transmitted message) and therefore includes both the intended, meaningful signal, and also includes any noise. The wireless data communication may be a wireless data packet.

The candidate time-of-arrival values are generated using at least signal eigenvectors (which are derived from the received wireless data communication), and the likelihood measure values are generated (i.e. calculated) based at least on noise eigenvectors derived from the received wireless data communication. Signal eigenvectors will be understood as referring to eigenvectors of the signal subspace, i.e. the meaningful part of the received wireless data communication, encoding meaningful data, whereas the noise eigenvectors will be understood as referring to eigenvectors of the noise subspace. Signal eigenvectors may be those eigenvectors of the received wireless data communication whose corresponding eigenvalue is higher than a threshold value, and noise eigenvectors may be the rest of the eigenvectors, i.e. whose corresponding eigenvalues are below the threshold value. This may provide a practical implementation to enable separation of the signal eigenvectors from the noise eigenvectors.

The likelihood measure (e.g. metric, equation) will be understood as being indicative of the likelihood that a particular time-of-arrival value is accurate, i.e. physically meaningful and corresponding to the arrival time of the signal in reality. The likelihood measure may achieve this by being representative of (e.g. proportional to) a relative angle between the arrival vector of received data and the noise subspace. For example, by being a function which peaks when the arrival vector is perpendicular to the noise subspace, since this would indicate that the data received at that particular point in time corresponds to the start of a meaningful data transmission, i.e. rather than being noise.

The time of arrival is determined. It will be understood that the determined time-of-arrival may be a relative time of arrival (e.g. relative to a known or benchmark time), i.e. a time offset, from which an absolute time of arrival may be calculated, i.e. by adding or subtracting the offset from the known time. For example, the time of arrival that is determined may be a time offset of the actual receipt time of the signal from a coarse time-of-arrival determined for the received signal (i.e. the packet detection time). The packet detection may be carried out by correlating a known pattern (e.g. long training fields—LTF) within the header of a packet with the incoming signal to detect a peak of the correlation value. The receiver may adjust the packet detection time in order to best align detected symbols with actual received symbols but this alignment is of limited accuracy. The misalignment may be due to a combination of the granularity of packet detection time (e.g. 50 ns at 20 MHz bandwidth), noise and multipath effects in the RF channel. In OFDM, any misalignment between packet detection time and the actual beginning of the LTF symbol will introduce a phase shift on subcarriers in the channel frequency response. Therefore the method in this invention may process the channel frequency response in order to estimate the time offset between the packet detection time and the actual beginning of the LTF symbol, so as to obtain a more accurate (i.e. “fine”) time measurement. It will be understood that there may be some error, or error margin, in the calculation, such that the time of arrival which is said to be determined is effectively estimated, e.g. with a configurable or measurable degree of granularity or accuracy. The determined time of arrival (i.e. time-offset) may be added to the coarse time-of-arrival to give the estimated time of arrival (also referred to as the fine time-of-arrival), and this together with a time-of-departure (i.e. transmission time) may be used to determine a time of flight of a signal.

In some embodiments, selecting a value of the candidate time-of-arrival values as the determined time-of-arrival for the received wireless data communication comprises comparing the likelihood measure value for each candidate time-of-arrival to a predetermined threshold, and determining each candidate time-of-arrival for which the likelihood measure value exceeds the predetermined threshold as being a valid candidate time-of-arrival value (i.e. so as to generate a set of valid candidate values), and selecting a time-of-arrival value from the set of valid time-of-arrival values. Checking the values of the likelihood measure against a threshold, and eliminating those for which the value does not meet the threshold, excludes those which have a low likelihood of being valid (i.e. reflecting physical reality) and therefore improves the accuracy of the method.

In some embodiments, the time-of-arrival value is selected from the candidate values based (at least) on the values of the likelihood measure and the magnitude of the values. For example, based at least one the candidate having a lowest value of the candidate values (or a subset of the candidate values). In some embodiments, selecting a time-of-arrival from the set of valid time-of-arrivals values comprises selecting the (valid) candidate having the lowest value as the determined time-of-arrival. Selecting the lowest valid time of arrival candidate as the time of arrival improves the chances of that being the correct time of arrival value (which reflects the physical reality) since any later times of arrival, even if having a higher likelihood measure value, are likely due to delays or reflections of the initial signal received at the lowest time of arrival.

The wireless data communication may be received from a second electronic wireless communication device (i.e. a transmitter, from which the wireless data communication is transmitted). The electronic wireless communication device (i.e. the receiver) may be a mobile electronic device, such as a mobile telephone. The second (i.e. transmitting) device may be a WiFi™ access point. The wireless data communication may therefore be a communication under the WiFi protocol. The invention thus extends to a wireless communication system comprising:
an electronic wireless communication device as described herein above; and
a second electronic wireless communication device, the second electronic wireless communication device configured to transmit the wireless data communication to the electronic wireless communication device,
wherein the second electronic wireless communication device is a WiFi access point.

Alternatively, the second electronic wireless communication device (i.e. transmitter) may be a mobile electronic device and the (receiving) electronic wireless communication device may be a WiFi access point. Thus, the described calculation or method may be carried out by a mobile electronic device or a WiFi access point, or, in some embodiments, may be carried out by both (e.g. as they send and receive communications to/from each other as part of a communication protocol).

In some embodiments, the calculation (or method) further comprises deriving the separation distance between the transmitting device and the receiving device based on the determined time of arrival and/or deriving the location of the electronic wireless communication device (or the second, i.e. transmitting electronic wireless communication device) based on (at least) the determined time-of-arrival. The calculation (or method) may further comprise receiving one or more additional wireless data communications from the electronic wireless communication device and/or one or more further electronic wireless communication devices, deriving respective times-of-arrival for each received wireless data communication, and triangulating the position of the wireless communication device based on these times of arrival (e.g. based on relative distance measures calculated from each time of arrival), or determining the position of the transmitter device.

The accurate time-of-arrival determination method described herein is particularly advantageous for use in determining time-of-arrival of WiFi signals because this allows accurate indoor location, which is otherwise technically very challenging, and it does so using largely existing infrastructure (i.e. WiFi access points which are generally already distributed throughout most buildings). Once a location within a building is achieved this information can be used to provide location-dependent behaviours, as explained above.

It is known for wide bandwidth systems (e.g. 500 MHz; UWB), to analyse the Channel Impulse Response (CIR) to find out the first peak index (FPI) that represents the relative timestamp when the signal arrives. At 500 MHz sample rate, the sample index resolution is 2 ns which is equivalent to 0.6 m. With considerations of heuristics such as edge slope, one can expect the average error to be lower than 0.6 m. However, low-power WiFi devices often have much lower bandwidth (20-40 MHz). At 20 MHz, the sample index resolution is 50 ns which is equivalent to 15 m. Even with heuristics, one can expect the average error to be several meters which is too large for many applications. Accurate location is therefore difficult to achieve using such known methods at WiFi bandwidth. More sophisticated methods are known which can achieve higher accuracy even at low bandwidths, but these generally require an exceptionally high computation capability that is not attainable in terms of both processing time and energy consumption by embedded CPUs.

In some embodiments, the candidate time-of-arrival value(s) are generated using only the signal eigenvectors derived from the received wireless data communication (i.e. and not using the noise eigenvectors). Alternatively, in other embodiments, the candidate time-of-arrival value(s) are generated using both the signal eigenvectors and the noise eigenvectors derived from the received wireless data communication.

For example, this could be achieved by also generating candidate values using noise eigenvectors (e.g. using the known Root-MUSIC method), and then combining or averaging these candidate values with those generated using signal eigenvectors in a suitable way to provide a single set of time-of-arrival values for which the likelihood measure value is generated.

In some embodiments, the candidate time-of-arrival values are generated using the ESPRIT algorithm (i.e. the known technique referred to as estimation of signal parameters via rotational invariance techniques).

In some embodiments, generating at least one candidate time-of-arrival value comprises determining a correlation matrix for the received wireless data communication.

In some embodiments, generating at least one candidate time-of-arrival value further comprises deriving signal eigenvectors and noise eigenvectors for the received wireless data communication, e.g. deriving the signal eigenvectors and noise eigenvectors from the determined correlation matrix by eigen decomposition or singular value decomposition. Deriving signal eigenvectors and noise eigenvectors may comprise performing an eigen decomposition to determine a set of eigenvectors and corresponding eigenvalues, and then designating a first subset of the eigenvectors, the eigenvalues of which exceed a (e.g. predetermined) threshold value, as signal eigenvectors, and designating the remaining eigenvectors (i.e. a second subset of the eigenvectors), the eigenvalues of which are below the threshold value, as noise eigenvectors.

In some embodiments, generating at least one candidate time-of-arrival value (further) comprises estimating a rotation matrix by solving a linear system of equations (e.g. AΨ=B, where Y is the rotation matrix).

In some embodiments, generating at least one candidate time-of-arrival value (further) comprises performing an eigen decomposition of the rotation matrix, wherein the angle of each determined eigenvalue represents a candidate phase offset. The calculation (and/or method) may further comprise converting the candidate phase offsets to corresponding time offsets (e.g. from a coarse time-of-arrival).

In some embodiments, generating at least one candidate time-of-arrival value may comprise generating less than 100 candidates, optionally less than 20 candidates, further optionally less than 10 candidates. It may comprise generating more than one candidate, optionally more than 2, optionally more than 5.

In some embodiments, generating at least one candidate time-of-arrival value may comprise generating at least a first candidate value, a second candidate value, and a third candidate value, the first, second and third candidate values adjacent in an ordering (i.e. size ordering) of candidate values, wherein the separation between the first candidate value and the second candidate value is different (i.e. in magnitude) to the separation between the second candidate value and the third candidate value. Thus, the candidate time-of-arrival values may be unequally separated in time. This therefore differs from known methods in which candidate time values at regularly spaced intervals are tested for their likelihood.

In some embodiments, the values of the likelihood measure are generated using only the noise eigenvectors derived from the received wireless data communication (i.e. and not using the signal eigenvectors). Alternatively, in other embodiments, the values of the likelihood measure are generated using both the signal eigenvectors and the noise eigenvectors derived from the received wireless data communication (i.e. the likelihood measure is based on both the signal eigenvectors and the noise eigenvectors).

In some embodiments, the likelihood measure is the likelihood measure used in the MUSIC algorithm (i.e. the known technique referred to as MUltiple Signal Classification).

In some embodiments, the likelihood measure is given by the formula

$$P ( τ ) = \frac{1}{{a ( τ )}^{H} {E}_{N} {E}_{N}^{H} a ( τ )} .$$

wherein E_{N} represents the noise eigenvectors spanning the noise subspace (i.e. the noise eigenvectors) derived from the received wireless data communication, and a(τ) is the time steering vector at a particular candidate time τ. In the channel frequency response of orthogonal frequency division multiplexing (OFDM) systems, the phase offset induced on i^{th} sub-carrier according to a time offset τ from the start of a symbol is 2πiΔf τ where Δf is the frequency step (e.g. 312.5 khz in a 20 MHz bandwidth and 64-sub-carriers). The time-steering vector of this embodiment may be a vector which represents this amount for all sub-carriers a(τ)={1, e^{-jφ}, e^{-j2φ}, . . . , e^{-jNφ}} (letting φ=2πΔf τ).

As set out above, fewer than 100 candidates (optionally fewer than 20 or 10 may be generated). Therefore, generating the values of the likelihood measure may comprise generating fewer than 100 values of the likelihood measure (each corresponding to a candidate time-of-arrival), optionally generating fewer than 20, further optionally less than 10.

The calculation (and method) may be carried out by any suitable component of the electronic wireless communication device. It may all be carried out by the processor of the electronic wireless communication device, but this may be quite time consuming (particularly where the processor is quite lightweight) and this may occupy the processor for a long period of time. Thus preferably some steps of the calculation (i.e. of the method) are carried out by a specialised (hardware) accelerator, in order to speed up the process and reduce the time for which the processor is occupied.

In some embodiments, the electronic wireless communication device comprises a processor and a hardware accelerator. In some embodiments the processor has a low clock frequency, e.g. a frequency of 128 MHz or 160 MHz. The use of a hardware accelerator is particularly advantageous with such a processor which would otherwise be slow to carry out the calculation. The electronic wireless communication device may include no floating-point processing unit (FPU). It thus may advantageously be possible, particularly through the provision of the (specialised) hardware accelerator, for such a device without an FPU to carry out the calculation relatively quickly. This may meet a speed threshold, e.g. be sufficiently quick for certain protocol requirements, and/or practical requirements.

Generating the candidate time-of-arrival values and/or the values of the likelihood measure may comprise using (i.e. at least) the hardware accelerator, i.e. using the hardware accelerator for at least some parts of the stated operations.

In some embodiments the hardware accelerator is a Givens accelerator or a Cordic accelerator. A Givens or Cordic accelerator may be understood as one arranged to carry out certain Givens/Cordic operations, e.g. vectoring and/or rotation. This is particularly suitable, since for some examples of the method, such an accelerator may be well-suited to carrying out multiple stages of the method, e.g. eigen decompositions, as described further below.

In some embodiments, the calculation comprises deriving, by the hardware accelerator, signal eigenvectors and noise eigenvectors for the received wireless data communication from the determined correlation matrix by eigen decomposition, i.e. this derivation is carried out by the hardware accelerator. In some embodiments, the hardware accelerator derives the signal eigenvectors and noise eigenvectors (i.e. performs the eigen decomposition) by performing one or more Givens rotations.

The calculation comprises solving a linear system of equations to estimate a rotation matrix (e.g. AΨ=B, where Ψ is the rotation matrix). In some embodiments, the hardware accelerator is configured to perform Givens rotations to both sides of the linear system of equations, optionally until the matrix on the same side as the rotation matrix (i.e. matrix A) becomes a triangular matrix, and (further optionally) then to solve for the rotation matrix by substitution.

In some embodiments, the calculation comprises carrying out, by the hardware accelerator, an eigen decomposition of the rotation matrix. In some embodiments, the hardware accelerator performs the eigen decomposition (i.e. of the rotation matrix) by performing one or more Givens rotations.

The hardware accelerator therefore accelerates these key steps of the method, and may do so particularly advantageously where all three steps (the two eigen decompositions and the solving of the linear system of equations) are achieved by performing Givens rotations, since the hardware accelerator may be optimised specifically for that operation.

As a result of the hardware accelerator, the electronic wireless communication device may (be able to, be configured to) determine the time-of-arrival of the received wireless data communication in less than 20 milliseconds, optionally less than 10 milliseconds, further optionally less than 5 milliseconds.

Features of any aspect or embodiment described herein may, wherever appropriate, be applied to any other aspect or embodiment described herein. Where reference is made to different embodiments or sets of embodiments, it should be understood that these are not necessarily distinct but may overlap. It will furthermore be understood that references made to a method comprising a step correspondingly extend to a device or a module of that device “configured to” carry out a step, and vice versa.

### BRIEF DESCRIPTION OF THE DRAWINGS

An embodiment of the invention will now be described, by way of example only, with reference to the accompanying drawings, in which:

FIG. 1 is a flow diagram representing a method of determining an arrival time of a signal according to the prior art, known as MUSIC;

FIG. 2 is a flow diagram representing another method of determining an arrival time of a signal according to the prior art, known as ESPRIT;

FIG. 3 is a flow diagram representing a method according to an embodiment of the present invention;

FIG. 4 is a flow diagram representing stages 100 and 102 of FIG. 3 in greater detail according to an embodiment of the invention;

FIG. 5 is a schematic diagram of a mobile electronic wireless communication device according to an embodiment of the present invention; and

FIG. 6 shows two graphs, comparing outputs of a time-of-arrival calculation according to the method of the present invention (left) and a known approach referred to as phase slope (right).

### DETAILED DESCRIPTION

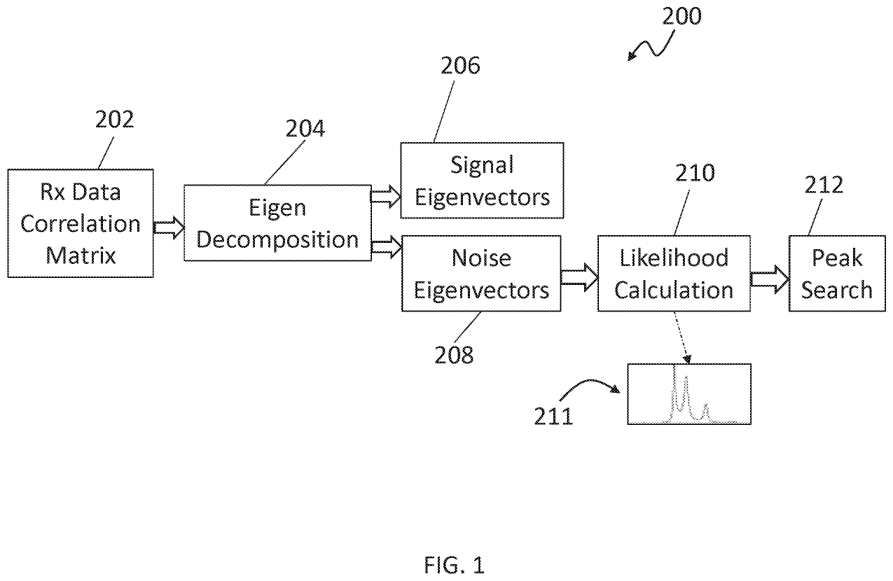

FIG. 1 is a flow diagram representing a method 200 of determining an arrival time of a signal according to the prior art. The illustrated method is known MUSIC, a contraction of Multiple Signal Classification.

It will be understood that in OFDM technology (commonly used in WiFi for example), the channel estimate, i.e. channel frequency response (CFR) is available to decode the received data. This CFR is used as an input for the time-of-arrival calculation as explained below. A Fourier transform is performed as part of the communication pipeline, i.e. decoding the data.

The MUSIC algorithm, when applied to time-of-arrival calculations, assumes that a received data signal (x) is made up of copies of a source signal through a multipath environment with white noise. In the frequency domain, the channel frequency response is modelled as:

$$X = As + n$$

Where X is the channel frequency response obtained from the received data signal x, A is a matrix A=[a(τ₁), . . . , a(τₚ)] of time steering vectors corresponding to delays P in different paths

$$a ( τ ) = {[ 1 , {e}^{- j 2 πΔ f τ} , … {e}^{- j 2 ( M - 1 ) πΔ fτ} ]}^{T}$$

Δf is the subcarrier bandwidth, n is Gaussian white noise and s is the amplitude vector of the form:

$$s = {[ {α}_{1} {e}^{- j 2 π {f}_{0} {τ}_{1}} , {α}_{2} {e}^{- j 2 π {f}_{0} {τ}_{2}} , … {α}_{p} {e}^{- j 2 π {f}_{0} {τ}_{p}} ]}^{T}$$

The method starts at step 202, in which the correlation matrix R is calculated for the received data (i.e. from the signals including noise), where:

$$R = {XX}^{H}$$

It will be understood that in practice this correlation matrix may be spatially-smoothed in any suitable known manner in order to better cope with multi-path environments.

Then, at step 204, an eigen decomposition (i.e. eigen analysis) of this correlation matrix R is carried out. This produces a number of eigenvalues associated with respective eigenvectors. Then the eigenvectors are separated out into signal eigenvectors E_{S} 206 and noise eigenvectors E_{N} 208 based on the size of their corresponding eigenvalue (i.e. signal eigenvectors have eigenvalues above a threshold, and the rest, with eigenvalues below the threshold are noise eigenvectors), i.e. such that E_{N} refers to the noise subspace, and E_{S} refers to the signal subspace.

Then, at step 210, a likelihood calculation is carried out, by deriving the value of a function P(τ) which has sharp peaks at the time-of-arrival values of interest. The time steering vector a(τ) is in the signal subspace and is orthogonal to the noise subspace when t exactly coincides with each time of arrival of the signal. The MUSIC ToA spectrum measures the distance (in a vector space defined by the array correlation matrix above) between the time steering vector and the noise subspace, as t varies, thus estimating the time of arrival of multiple signals by determining the value of time-of-arrival at which a particular function P(τ) peaks.

P(τ) is defined as:

$$P ( τ ) = \frac{1}{{a ( τ )}^{H} {E}_{N} {E}_{N}^{H} a ( τ )}$$

The granularity can be chosen by selecting how many time-of-arrival values to calculate a value of P(τ) for. Where this time-of-arrival value is used in distance calculation, and location determination, this selection can therefore determine the resolution with which position is determined. It will be appreciated that where distance is calculated for signals travelling at the speed of light (e.g. RF signals) then a very large number of time values must be calculated to obtain a reasonable resolution, e.g. nearly 1000 calculations across a wave length corresponding to the subcarrier bandwidth in a 20 MHz channel to get to a resolution of only 1 m. For example, a 64-subcarrier symbol has a frequency step of 312.5 KHz which is equivalent to a wavelength of 960 m. For many applications a much higher resolution would be needed, realistically requiring tens of thousands of calculations. This likelihood calculation 210 produces effectively a spectrum (i.e. a pseudo-spectrum) of likelihood across a range of likelihood values, an example of which is illustrated in a graph 211 shown in FIG. 1.

Furthermore, once all of the P(τ) values are calculated, to give this pseudo-spectrum 211, a peak search must be carried out across all of these calculated values to identify the peaks in this spectrum. This is illustrated at step 212 in FIG. 1. Then the lowest significant peak is selected as the one giving the time-of-arrival value, i.e. the value at its centre is determined as the time-of-arrival. As an alternative to steps 210 and 212 (i.e. to computing a large number of values of P (T) and then searching for peaks in those values), a root-finding operation could be carried out based on the P(τ) equation.

It will be appreciated that this method is extremely computationally expensive-both in order to carry out the likelihood calculation, i.e. determined the values of P(τ) for all of the selected candidate time-of-arrival values, and also to then carry out the peak search to determine where that function has peaks. Thus, it either requires significant device capabilities, or takes a very long time to complete.

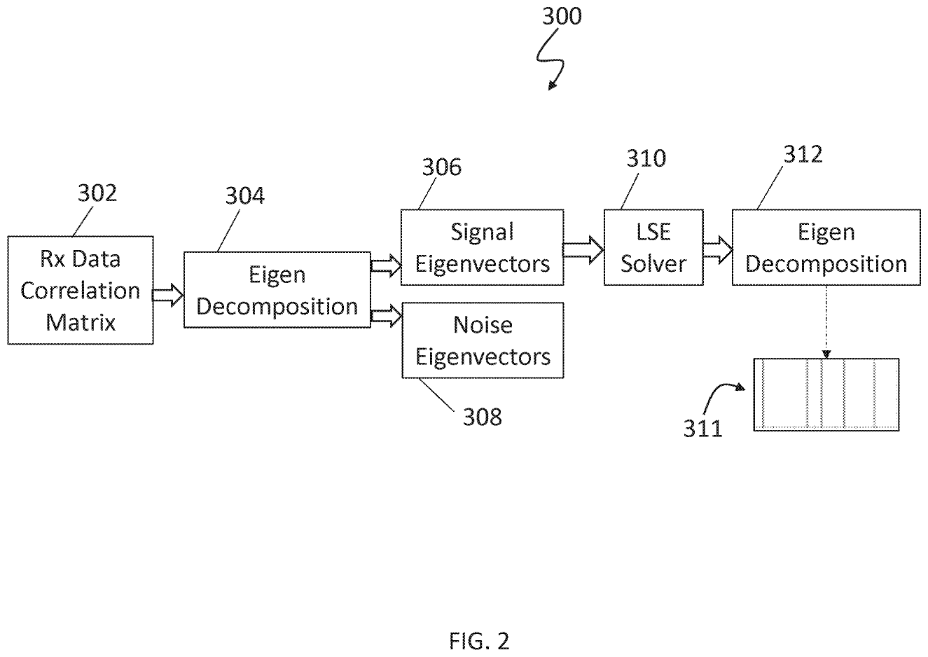

An alternative known time-of-arrival determination method 300 is illustrated in FIG. 2. This method is known as ESPRIT (from Estimation of signal parameters via rotational invariant techniques). Steps 302 and 304 (giving rise to signal eigenvectors 306 and noise eigenvectors 308) are analogous to steps 202 and 204 of the method of FIG. 1, and are therefore not described again. Thus the first step of the ESPRIT method is to perform an eigen decomposition of the correlation matrix R of the Channel Frequency Response (CFR) of the input signal (i.e. wireless data communication). This step is thus shared with the first step in the MUSIC algorithm.

The objective of ESPRIT is to find a matrix φ that specifies the phase offset between two consecutive sub-arrays in the channel frequency response (i.e. the first sub-array includes subcarriers 1 to L−1; the second sub-array includes the subcarriers 2 to L where L is the number of subcarriers).

$${X}_{1} = As + {n}_{1}$$

$${X}_{2} = A Φ s + {n}_{2}$$

Where φ is a diagonal matrix defined as:

$$Φ = [ \begin{matrix}{e}^{j ϕ 1} & … & \\ ⋮ & ⋱ & ⋮ \\ & … & {e}^{j ϕ N}\end{matrix} ]$$

Each diagonal element in φ corresponds to a phase offset introduced by a different path in a multipath environment. Diagonal elements in φ may be determined indirectly via another rotation matrix Ψ that rotates (or transforms) an eigenvector into another eigenvector in the signal subspace.

So, the signal eigenvectors 306, denoted by E_{S}, are divided out to give two matrices, E_{S}¹, which is a sub-matrix including all signal vectors 1 to M−1, and E_{S}² which is a sub-matrix including all signal vectors from 2 to M. Where M is the number of signal eigenvectors. M may be estimated from the eigen values (e.g. the number of eigen values that are higher than a threshold).

As a result of the invariance structure assumed under this approach, it follows that Eₛ¹Ψ=Eₛ², wherein Ψ defines the rotation matrix that rotates (or transforms) the first set of eigenvectors Eₛ¹ into the second set of eigenvectors (as explained, for example, in “ESPRIT-Estimation of Signal Parameters Via Rotational Invariance Techniques” Richard Roy and Thomas Kailath, IEEE Transactions on Acoustics, Speech, and Signal Processing, Vol. 37, No. 7 Jul. 1989, pages 984-995). It holds that there exists a matrix F such that:

$$Ψ = {F}^{- 1} Φ F$$

Therefore the angles of the eigen values of Ψ are equal to the angles of the (diagonal) elements in φ, where φ is the diagonal matrix described above.

This linear system of equations is solved, at step 310, to estimate the rotation matrix Ψ.

Then, at stage 312, which is the second eigen decomposition stage, the eigenvalues Λᵢ=αᵢe^{jφi}, of the rotation matrix Ψ are determined.

Since the angle of each eigenvalue of the rotation matrix Ψ, φᵢ=arg(Λᵢ), is equal to the phase term of one of the diagonal elements in the diagonal matrix φ, this angle is used as a candidate phase offset or phase shift, and because the subcarriers are cosine waves, a time offset will introduce a corresponding phase offset therefore a time offset may be determined from the derived phase offset.

This phase offset is introduced into the channel frequency response because of the misalignment between the detected symbol and the actual beginning of the symbol. This phase offset is then converted to a time offset candidate using the equation:

$${τ}_{i} = \frac{{ϕ}_{i}}{2 π Δ f}$$

This eigen decomposition 312 thus produces a series of candidate values, e.g. as illustrated in the graph 311. Then, one of these values, generally the lowest, is selected as the determined time of arrival.

Thus, using the method outlined above, ESPRIT produces a set of candidate time-of-arrival (or angle-of-arrival) values. The lowest of these is then selected as the calculated time of arrival, since later times of arrival are generally due to reflections or delayed versions of the original signal.

Thus, ESPRIT also provides a possible solution to determine a time-of-arrival value, but it produces specific candidates, based on the derived eigenvalues, rather than producing a pseudo-spectrum as MUSIC does. Furthermore, as explained, it derives these values based on the signal eigenvectors rather than the noise eigenvectors.

This method is much less computationally expensive than the MUSIC method of FIG. 1, but it has a much higher incidence of false positives. It is therefore possible that when you select the time-of-arrival by choosing the lowest derived candidate value, it could be an entirely false time-of-arrival value. This method is therefore more inaccurate than the method described with reference to FIG. 1.

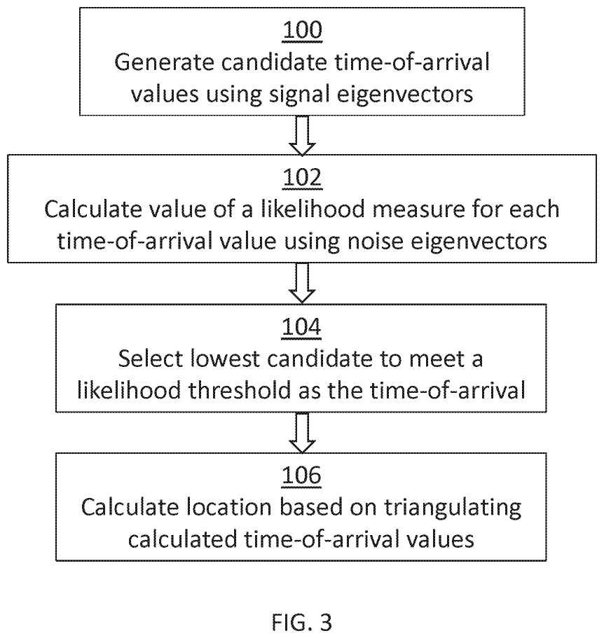

FIG. 3 is a flow diagram showing a method of calculating a time-of-arrival (which may also be referred to as time-of-flight) of a received signal according to an embodiment of the present invention.

At step 100, a plurality of candidate time-of-arrival values are generated from at least the signal eigenvectors E_{S} of the received signal (and optionally also from the noise eigenvectors E_{N}).

Next, at step 102, the value of a likelihood measure (i.e. metric) is calculated for each of the candidate time-of-arrival values. This likelihood measure may also be considered as a closeness calculation.

At step 104, it is determined which of the candidates have an associated likelihood measure the value of which exceeds a predetermined threshold. These set of candidate time-of-arrival values for which the likelihood measure value exceeds the threshold value are considered to be the valid candidates. Filtering down all of the candidate values generated by step 100 to only those which are considered to be valid, based on their respective likelihood measure values as derived at step 102, helps to eliminate any false candidate values which may have been generated in step 100, since those false candidates would have low likelihood measure values. This likelihood measure is calculated using at least the noise eigenvectors E_{N} (and optionally also the signal eigenvectors E_{S}).

The lowest of these valid candidates is selected, at step 104, as the determined time-of-arrival value. The lowest is selected (e.g. rather than the one for which the likelihood measure has the highest value) because later arrival times are likely to be due to delayed or reflected versions of the signal which are received later than the initial received signal.

At step 106, the calculated time-of-arrival value is used (optionally together with other time-of-arrival values determined based on other received signals, possibly received from other receivers), to determine a location of either the receiving device or one of the transmitting devices by triangulation, in a known manner. Time-of-departure values may also be shared between devices, in order to facilitate time-of-flight calculations, e.g. via the known protocol in FTM.

The Applicant has appreciated that deriving the time-of-arrival values based on candidates generated using (at least) signal eigenvectors, and checked using a likelihood measure generated using (at least) noise eigenvectors, provides a particularly advantageous method providing good accuracy with relatively low computational requirements.

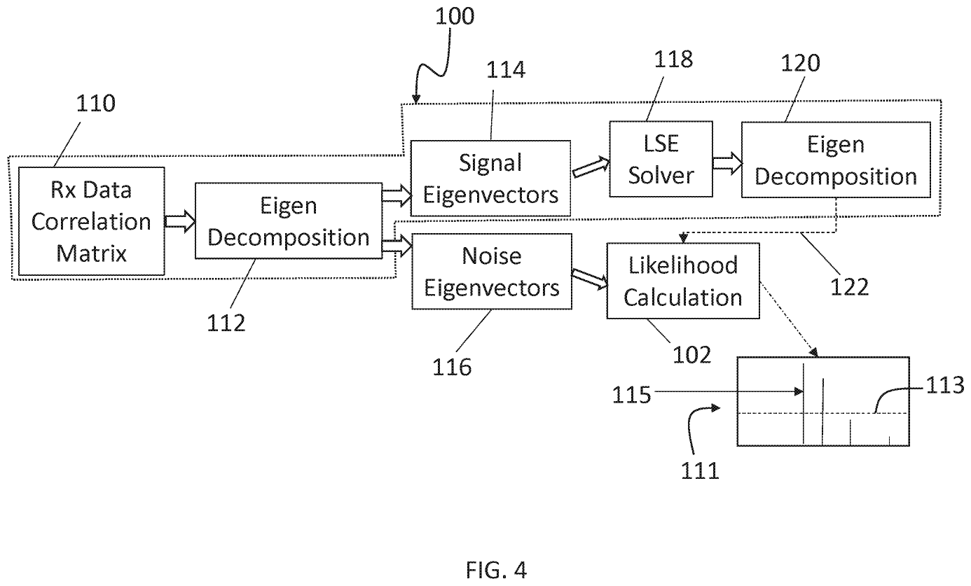

FIG. 4 is a flow diagram illustrating one possible example of the way in which steps 100 and 102 of FIG. 3 may be carried out. In this example the candidate values at step 100 are generated using the ESPRIT method of FIG. 2. Step 100 in this example is therefore achieved by the steps which are shown surrounded by a dotted line.

Thus, in this example, the method begins, at step 110 with derivation of the correlation matrix R for the received signal and then, at step 112, with eigen decomposition of this correlation matrix R, as described above in relation to FIGS. 1 and 2, separating out signal eigenvectors 114 and noise eigenvectors 116. This eigen decomposition may be achieved by performing one or more Givens rotations.

As an alternative to an eigen decomposition at step 112, the method may instead comprise carrying out a singular value decomposition (SVD) at this stage, to separate out the signal and noise eigenvectors.

Then, the method continues with the LSE solver 118 and then a further eigen decomposition 120, as described above with reference to FIG. 2. In this particular example, the LSE solver stage 118 applies the same Givens rotations on both sides of the equation Eₛ¹Ψ=Eₛ² until the matrix Eₛ¹ becomes a triangular matrix. The rotation matrix Y is then found by substitution. The second eigen decomposition 120 is also achieved, in this example, by performing one or more Givens rotations on the rotation matrix. The Applicant has thus appreciated that the two eigen decompositions steps 112, 120 can also (i.e. in addition to the LSE solver stage 118) be achieved using Givens rotations.

At step 102, the value of a likelihood measure is calculated for each of the generated candidate time-of-arrival values. This is illustrated by the arrow 122, representing these candidate time-of-arrival values passing to the likelihood calculation step 102. In the example of FIG. 4, the likelihood measure used at stage 102 is the metric P (T) used in the MUSIC algorithm as described above, and is therefore calculated using the noise eigenvectors 116 which are generated at the eigen decomposition (or SVD) stage 112.

However, unlike the MUSIC algorithm of FIG. 1, the method according to the present invention does not need to calculate the likelihood measure for many thousands of values to obtain a reasonable result. Rather, the first step 100 generates a handful of candidate time-of-arrival values, e.g. less than 10, optionally approximately or less than 6. The value of the likelihood measure is then only calculated for these few candidate values at step 102. An example result of the likelihood calculation is illustrated in the graph 111 of FIG. 4, with arrival time on the x-axis and likelihood measure value on the y-axis. As can be seen, this produces not only a plurality of candidate values, but an associated likelihood measure for each candidate value, represented by the relative height of each line. Only those values which exceed the illustrated pre-determined threshold (which may be set using any suitable method) are considered to be valid, and then the determined time-of-arrival is selected as the lowest of these valid values, i.e. in this case the time-of-arrival represented by line 115.

This particular example method, advantageously incorporating steps of the known methods described with reference to FIGS. 1 and 2, is particularly advantageous since the use of the likelihood measure of FIG. 1 helps to eliminate any false candidates which may be generated by the technique of FIG. 2, providing improved accuracy, whereas generating candidate values using the method of FIG. 2 allows the likelihood measure to be calculated for far fewer candidates than in the method of FIG. 1, thereby significantly reducing computational requirements without compromising accuracy.

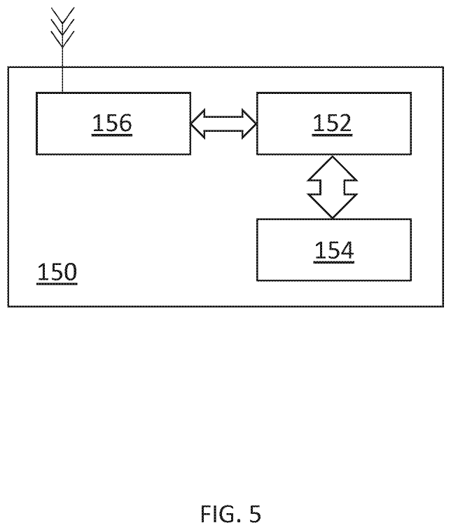

FIG. 5 illustrates a mobile electronic wireless communication device 150 (e.g. a mobile telephone). This device 150 is arranged to carry out the method of FIGS. 3 and 4 based on received wireless signals, and in particular based on received WiFi signals. The wireless signals (e.g. wireless data communication or data packet(s)) are received by a receiver 156 which forms part of the mobile electronic wireless communication device 150. Initial processing steps may be carried out at the receiver 156 (e.g. by a processing device forming part of the receiver) or the (i.e. raw) data may be sent directly to the processor 152 (discussed below) for processing.

The device 150 includes a processor 152, e.g. a central processing unit (CPU). This processor 152 carries out other processes of the device, e.g. other processing functions, and also carries out certain steps of the method of FIGS. 3 and 4.

However, it has been appreciated that the two eigen decomposition steps 112, 120 of the method as well as the LSE solver 118 are the most computationally expensive and time consuming, i.e. they are the bottlenecks of the process.

Therefore, in order to improve the performance of the described method, the mobile electronic wireless communication device 150 further comprises a hardware accelerator 154, which may be, for example a Givens or Cordic accelerator. Such accelerators are relatively lightweight, but very well suited to carrying out the required eigen decomposition and LSE solving steps. Thus these processes 112, 120, 118 are advantageous offloaded from the processor 152 and instead carried out by the hardware accelerator.

A Givens accelerator, for example, may take up only 20 k gates in gate equivalent area, and is therefore lightweight, whereas it may reduce the processing time to carry out the processes 112, 120 and 118 of FIG. 4 for an eigen decomposition of size 13×13 from 6.3 million cycles (if using software only) to 280 k cycles if using the Givens hardware accelerator. This may reduce the time for the device 150 to complete the whole algorithm of FIG. 4 on a particular received data set to 980 k cycles. Although not illustrated, the illustrated device 152 may alternatively be a WiFi access point (AP), i.e. a fixed transmitting or receiving device.

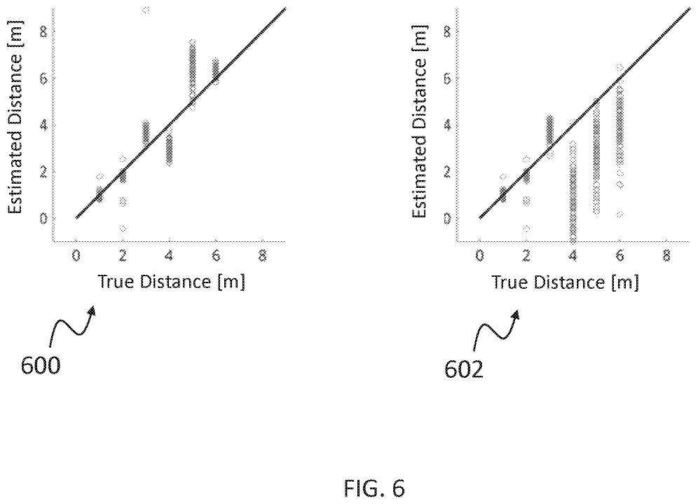

FIG. 6 shows two graphs, a first graph (left) 600 showing the result of various time-of-arrival calculations (y-axis) corresponding to various different actual travel distances (x-axis), according to the method of the present invention and a second graph (right) 602, showing the result of time-of-arrival calculations for the same signals according to a known approach referred to as phase slope. It can be seen that the present method provides a similar result at lower travel distances and performs particularly well at larger travel distances (i.e. over 4 m) compared to the phase slope method, which significantly underestimates the travel distance. Time-of-arrival determination is particularly challenging for signals that have travelled longer distances because multi-path effects are more significant in such cases.

1. An electronic wireless communication device, comprising a receiver, arranged to receive a wireless data communication, the electronic wireless communication device configured to carry out a time-of-arrival calculation to determine a time-of-arrival of the received wireless data communication, the calculation comprising:
generating, using at least signal eigenvectors derived from the received wireless data communication, at least one candidate time-of-arrival value for the received wireless data communication;
generating, using at least noise eigenvectors derived from the received wireless data communication, a value of a likelihood measure for each of the generated candidate time-of-arrival values;
selecting a value of the candidate time-of-arrival values as the determined time-of-arrival for the received wireless data communication, based at least on the values of the likelihood measure.

2. The electronic wireless communication device of claim 1, wherein the electronic wireless communication device comprises a processor and a hardware accelerator, wherein generating the candidate time-of-arrival values comprises using the hardware accelerator and generating the values of the likelihood measure comprises using the hardware accelerator.

3. The electronic wireless communication device of claim 2, wherein the hardware accelerator is a Givens accelerator or a Cordic accelerator.

4. The electronic wireless communication device of claim 1, wherein the candidate time-of-arrival value(s) are generated using only the signal eigenvectors derived from the received wireless data communication.

5. The electronic wireless communication device of claim 1, wherein the candidate time-of-arrival values are generated using the ESPRIT algorithm.

6. The electronic wireless communication device of claim 1, wherein generating at least one candidate time-of-arrival value comprises determining a correlation matrix for the received wireless data communication.

7. The electronic wireless communication device of claim 6, wherein generating at least one candidate time-of-arrival value comprises deriving signal eigenvectors and noise eigenvectors for the received wireless data communication from the determined correlation matrix by eigen decomposition or singular value decomposition.

8. The electronic wireless communication device of claim 7, wherein the electronic wireless communication device comprises a hardware accelerator, wherein generating at least one candidate time-of-arrival value comprises deriving signal eigenvectors and noise eigenvectors for the received wireless data communication from the determined correlation matrix by eigen decomposition, and wherein the eigen decomposition is carried out by the hardware accelerator by performing one or more Givens rotations.

9. The electronic wireless communication device of claim 1, wherein generating at least one candidate time-of-arrival value comprises estimating a rotation matrix by solving a linear system of equations.

10. The electronic wireless communication device of claim 9, wherein generating at least one candidate time-of-arrival value comprises performing an eigen decomposition of the rotation matrix, wherein the angle of each determined eigenvalue represents a candidate phase offset.

11. The electronic wireless communication device of claim 1, wherein generating at least one candidate time-of-arrival value for the received wireless data communication comprises generating less than 20 candidate time-of-arrival values.

12. The electronic wireless communication device of claim 1, wherein the values of the likelihood measure are generated using only the noise eigenvectors derived from the received wireless data communication.

13. The electronic wireless communication device of claim 1, wherein the likelihood measure is the likelihood measure used in the MUSIC algorithm.

14. The electronic wireless communication device of claim 1, wherein the likelihood measure is given by the formula
$$P ( τ ) = \frac{1}{{a ( τ )}^{H} {E}_{N} {E}_{N}^{H} a ( τ )} .$$
wherein E_{N} represents the noise eigenvectors spanning the noise subspace derived from the received wireless data communication, and a(τ) is the time steering vector at a particular candidate time τ.

15. The electronic wireless communication device of claim 1, wherein selecting a value of the candidate time-of-arrival values as the determined time-of-arrival for the received wireless data communication comprises:
comparing the likelihood measure value for each candidate time-of-arrival to a predetermined threshold, and determining each candidate time-of-arrival for which the likelihood measure value exceeds the predetermined threshold as being a valid candidate time-of-arrival value; and
selecting a time-of-arrival value from the set of valid time-of-arrival values.

16. The electronic wireless communication device of claim 15, wherein selecting a time-of-arrival from the set of valid time-of-arrivals values comprises selecting the candidate time-of-arrival value having the lowest value as the determined time-of-arrival.

17. The electronic wireless communication device of claim 1, wherein the calculation further comprises deriving the location of the electronic wireless communication device based on at least the determined time-of-arrival.

18. An electronic wireless communication device, comprising a receiver, arranged to receive a wireless data communication, the electronic wireless communication device configured to carry out a time-of-arrival calculation to determine a time-of-arrival of the received wireless data communication, the calculation comprising:
generating, using at least signal eigenvectors derived from the received wireless data communication, at least one candidate time-of-arrival value for the received wireless data communication, using the ESPRIT algorithm;
generating, using at least noise eigenvectors derived from the received wireless data communication, a value of a likelihood measure for each of the generated candidate time-of-arrival values, wherein the likelihood measure is given by the formula
$$P ( τ ) = \frac{1}{{a ( τ )}^{H} {E}_{N} {E}_{N}^{H} a ( τ )} .$$
wherein E_{N} represents the noise eigenvectors spanning the noise subspace derived from the received wireless data communication, and a(τ) is the time steering vector at a particular candidate time τ;
selecting a value of the candidate time-of-arrival values as the determined time-of-arrival for the received wireless data communication, based at least on the values of the likelihood measure.

19. A wireless communication system, comprising:
an electronic wireless communication device as claimed in claim 1; and
a second electronic wireless communication device, the second electronic wireless communication device configured to transmit the wireless data communication to the electronic wireless communication device,
wherein the second electronic wireless communication device is a WiFi access point.

20. A method of carrying out a time-of-arrival calculation to determine a time-of-arrival of a received wireless data communication, the method comprising:
generating, using at least signal eigenvectors derived from the received wireless data communication, at least one candidate time-of-arrival value for the received wireless data communication;
generating, using at least noise eigenvectors derived from the received wireless data communication, a value of a likelihood measure for each of the generated candidate time-of-arrival values;
selecting a value of the candidate time-of-arrival values as the determined time-of-arrival for the received wireless data communication, based at least on the values of the likelihood measure.
